(19) United States
(12) Patent Application Publication
(10) Pub. No.: US 2022/0188621 A1
(43) Pub. Date: Jun. 16, 2022

(54) GENERATIVE DOMAIN ADAPTATION IN A NEURAL NETWORK

(71) Applicant: Ford Global Technologies, LLC, Dearborn, MI (US)

(72) Inventors: Praveen Narayanan, San Jose, CA (US); Nikita Jaipuria, Union City, CA (US); Apurbaa Mallik, Sunnyvale, CA (US); Punarjay Chakravarty, Campbell, CA (US); Ganesh Kumar, Santa Clara, CA (US)

(73) Assignee: Ford Global Technologies, LLC, Dearborn, MI (US)

(21) Appl. No.: 17/117,597

(22) Filed: Dec. 10, 2020

(51) Int. Cl. G06N 3/08; G06K 9/62; G06F 17/18

(52) U.S. Cl. CPC G06N 3/08; G06F 17/18; G06K 9/6228

(57) ABSTRACT

A system comprises a computer including a processor and a memory. The memory storing instructions executable by the processor to cause the processor to generate a low-level representation of the input source domain data; generate an embedding of the input source domain data; generate a high-level feature representation of features of the input source domain data; generate output target domain data in the target domain that includes semantics corresponding to the input source domain data by processing the high-level feature representation of the features of the input source domain data using a domain low-level decoder neural network layer that generate data from the target; and modify a loss function such that latent attributes corresponding to the embedding are selected from a same probability distribution.

### BACKGROUND

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

### BRIEF DESCRIPTION OF THE DRAWINGS

FIG. 1 is a diagram of an example vehicle system.

FIG. 2 is a diagram of an example server.

FIG. 3 is a diagram of an example domain transfer network.

FIG. 4 is another diagram of the example domain transfer network.

FIG. 5 is another diagram of the example domain transfer network that includes a discriminator.

FIGS. 6A through 6D are diagrams of an example discriminator.

FIG. 7 is a diagram illustrating example layers of the discriminator.

FIG. 8 is a diagram of an example deep neural network.

FIG. 9 is a flow diagram illustrating an example process for generating target domain data from source domain data.

FIG. 10 is a flow diagram illustrating an example process for generating source domain data from target domain data.

### DETAILED DESCRIPTION

Neural networks are used for many tasks that operate autonomous vehicles. For example, a neural network can input image data acquired by a vehicle sensor to determine objects in an environment around a vehicle and use the data regarding the objects to determine a vehicle path upon which to operate the vehicle. Neural networks can also be trained to determine commands spoken by an occupant of a vehicle and operate the vehicle based on the determined command. Spoken commands can include spoken phrases such as “go”, “stop”, and “turn left”, for example. Neural networks can also be trained to process video data to determine a real world location for a vehicle based on visual odometry, for example. Visual odometry is a technique for determining a location of a vehicle based on processing a sequence of video images to determine a vehicle location based on changes in locations of determined features in the sequence of video images. Features are arrangements of pixel values that can be determined in two or more video images. Neural networks can be trained to accomplish these tasks by gathering large amounts of training data that includes examples of input data and corresponding ground truth. The input data can be images of environments around vehicles including objects such as other vehicles and pedestrians. In other examples training data can include commands spoken by plurality of different people having differing voice characteristics. Ground truth is data corresponding to the correct output desired from a neural network acquired from a source independent from the neural network. In the example of image data, human observers can view the training images and determine the identity and location of objects in the image data. In the example of spoken commands, human listeners can listen to the spoken commands and determine the correct vehicle command corresponding to the spoken command.

An issue with training data is that large numbers, typically greater that 1000, of training examples can be required to train a neural network. Because each training example requires corresponding ground truth, compiling training datasets can be very expensive and require many person-hours of human labor to complete. Additional neural networks can be trained to generate simulated training data including ground truth from a smaller number of real world examples and thereby reduce the time and expense required to generate training datasets for neural networks. Training datasets generated in this fashion are only useful if the simulated training data accurately corresponds to the real-world data used to generate the simulated training data. Techniques discussed herein improve the process of generating training datasets using neural networks by improving techniques for generating accurate simulated training data based on limited amounts of input real-world training data thereby reducing the time and expense required to generate training datasets for neural network training. Techniques described herein can improve neural network generation of training datasets by improving determination of loss functions. Loss functions are used in training neural networks by comparing generated results with ground truth to determine differences between the generated result and corresponding ground truth.

A system comprises a computer including a processor and a memory. The memory storing instructions executable by the processor to cause the processor to generate a low-level representation of the input source domain data by processing source domain data using a source domain low-level encoder neural network layer corresponding to data from the source domain to generate a low-level representation of the input source domain data; generate an embedding of the input source domain data by processing the low-level representation using a high-level encoder neural network layer shared between data from the source and target domains; generate a high-level feature representation of features of the input source domain data by processing the embedding of the input source domain image using a high-level decoder neural network layer shared between data from the source and target domains to generate a high-level feature representation of features of the input source domain data; generate output target domain data in the target domain that includes semantics corresponding to the input source domain data by processing the high-level feature representation of the features of the input source domain data using a domain low-level decoder neural network layer that generate data from the target; and modify a loss function such that latent attributes corresponding to the embedding are selected from a same probability distribution.

In other features, the processor is further programmed to: modify the loss function by calculating a maximum mean discrepancy between a first latent attribute corresponding to a source domain and a second latent attribute corresponding to a target domain.

In other features, the processor is further programmed to: modify the loss function based on a prediction from a discriminator, wherein the prediction is indicative of a domain corresponding to a latent attribute.

In other features, the discriminator comprises one or more convolutional layers, one or more batch normalization layers, and one or more rectified linear unit layers.

In other features, a final layer of the discriminator comprises a softmax layer.

In other features, the discriminator generates a multidimensional vector representing the prediction.

In other features, the multidimensional vector comprises a four-dimensional vector corresponding to four domains.

In other features, the multidimensional vector comprises a two-dimensional vector corresponding to two domains.

In other features, a loss function for the discriminator comprises: L_{D}=\tilde{Z}_{AA} log D(Z_{AA})+\tilde{Z}_{BB} log D(Z_{BB})+\tilde{Z}_{AB} log D(Z_{AB})+\tilde{Z}_{BA} log D(Z_{BA}), where L_{D} is defined as the loss function, \tilde{Z}_{AA}, \tilde{Z}_{BB}, \tilde{Z}_{AB}, \tilde{Z}_{BA} are defined as labels for the corresponding domain, log D is defined as an estimate that the probability for the latent attribute corresponds to a specific domain, and Z_{AA}, Z_{AB}, Z_{BA}, Z_{BB} are defined as predicted domain outputs.

In other features, the processor is further programmed to: generate a low-level representation of the input target domain data by processing the input target domain data using a target domain low-level encoder neural network layer specific to data from the target domain; generate an embedding of the input target domain data by processing the low-level representation using a high-level encoder neural network layer that is shared between data from the source and target domains; generate a high-level feature representation of features of the input target domain data by processing the embedding of the input target domain image using the high-level decoder neural network layer shared between data from the source and target domains; and generate output source domain data from the source domain that includes semantics corresponding to the input target domain data by processing the high-level feature representation of the features of the target source domain image using a source domain low-level decoder neural network layer that is specific to data from the source domain.

A method comprises: generating a low-level representation of the input source domain data by processing source domain data using a source domain low-level encoder neural network layer corresponding to data from the source domain to generate a low-level representation of the input source domain data; generating an embedding of the input source domain data by processing the low-level representation using a high-level encoder neural network layer shared between data from the source and target domains; generating a high-level feature representation of features of the input source domain data by processing the embedding of the input source domain image using a high-level decoder neural network layer shared between data from the source and target domains to generate a high-level feature representation of features of the input source domain data; generating output target domain data in the target domain that includes semantics corresponding to the input source domain data by processing the high-level feature representation of the features of the input source domain data using a domain low-level decoder neural network layer that generate data from the target; and generate output source domain data from the source domain that includes semantics corresponding to the input target domain data by processing the high-level feature representation of the features of the target source domain image using a source domain low-level decoder neural network layer that is specific to data from the source domain.

In other features, the method includes: modifying the loss function by calculating a maximum mean discrepancy between a first latent attribute corresponding to a source domain and a second latent attribute corresponding to a target domain.

In other features, the method includes: modifying the loss function based on a prediction from a discriminator, wherein the prediction is indicative of a domain corresponding to a latent attribute.

In other features, the discriminator comprises one or more convolutional layers, one or more batch normalization layers, and one or more rectified linear unit layers.

In other features, a final layer of the discriminator comprises a softmax layer.

In other features, the discriminator generates a multidimensional vector representing the prediction.

In other features, the multidimensional vector comprises a four-dimensional vector corresponding to four domains.

In other features, the multidimensional vector comprises a two-dimensional vector corresponding to two domains.

In other features, a loss function of the discriminator comprises: L_{D}=\tilde{Z}_{AA} log D(Z_{AA})+\tilde{Z}_{BB} log D(Z_{BB})+\tilde{Z}_{AB} log D(Z_{AB})+\tilde{Z}_{BA} log D(Z_{BA}), where L_{D} is defined as the loss function, \tilde{Z}_{AA}, \tilde{Z}_{BB}, \tilde{Z}_{AB}, \tilde{Z}_{BA} are defined as labels for the corresponding domain, log D is defined as an estimate that the probability for the latent attribute corresponds to a specific domain, and Z_{AA}, Z_{AB}, Z_{BA}, Z_{BB} are defined as predicted domain outputs.

In other features, the method includes generating a low-level representation of the input target domain data by processing the input target domain data using a target domain low-level encoder neural network layer specific to data from the target domain; generating an embedding of the input target domain data by processing the low-level representation using high-level encoder neural network layer that is shared between data from the source and target domains; generating a high-level feature representation of features of the input target domain data by processing the embedding of the input target domain image using the high-level decoder neural network layer shared between data from the source and target domains; and generating output source domain data from the source domain that includes semantics corresponding to the input target domain data by processing the high-level feature representation of the features of the target source domain image using a source domain low-level decoder neural network layer that is specific to data from the source domain.

The present disclosure describes a domain adaptation network that can receive data, such as an image, from a source domain and transforms the data into data from a target domain having similar semantics to the source domain data, e.g., semantic contents within an image are maintained. Semantics in the present context refers to data, such as objects within an image, that are to be maintained between the images. Generally, the source domain, e.g., a daytime image or a virtual environment image, is different from the target domain, e.g., a nighttime image or a real-world image. For example, a distribution of pixel values in images from the source domain is different from the distribution of pixel values in images from the target domain. Thus, images that have the same semantics can look different if one image is from the source domain and the other image is from the target domain. For example, the source domain may be images of a virtual environment that simulates a real-world environment and the target domain may be images of the real-world environment.

Source domain images may be images of a virtual environment that simulates a real-world environment that is to be interacted with by an autonomous or semi-autonomous vehicle, while the target domain images may be images of the real-world environment as captured by the vehicle. During training, a loss function is used to update one or more weights of the domain adaptation network. As described in greater detail herein, a loss function can be modified such that latent attributes of an embedding are selected from a same probability distribution to create more realistic data in the target domain.

By transforming source domain images into target domain images, the target domain images can be used to develop a control policy for the vehicle or while training a neural network that is used to select actions to be performed by the vehicle. Thus a performance of the vehicle in the real-world environment may be improved by exposing the neural network and/or control policy to additional situations created within a virtual environment.

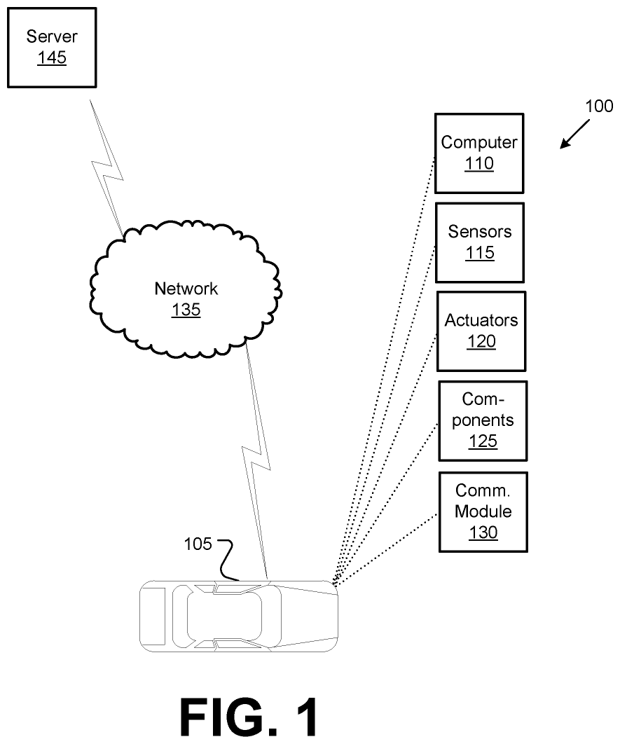

FIG. 1 is a block diagram of an example domain transfer network 300 for determining and transmitting a path recommendation for one or more vehicles. The domain transfer network 300 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a communication network 135, the communications module 130 allows the computer 110 to communicate with a server 145. The domain transfer network 300 also includes a roadside device 150, which can communicate with the server 145 and the vehicle 105 via the communication network 135, and validation devices 155.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (LIDAR) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g. front view, side view, rear view, etc., providing data from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the communication network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The communication network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

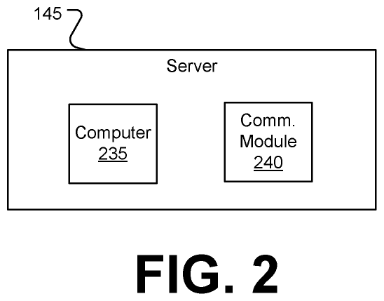

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105.

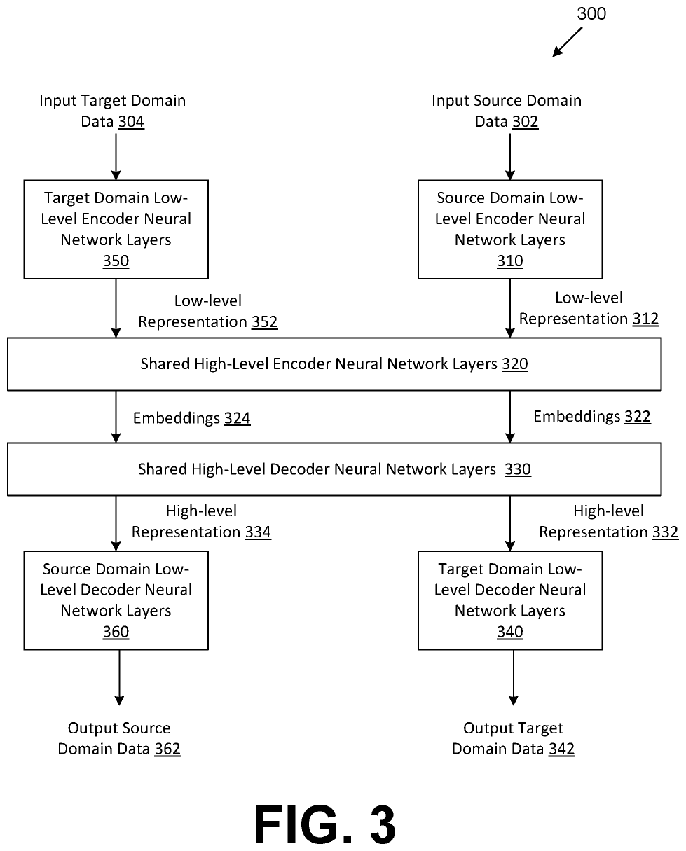

FIG. 3 illustrates an example domain transfer network 300 that can be implemented as one or more computer programs executable by the computer 110 and/or the server 145. The domain transfer network 300 is a system that transforms input source domain data 302 into output target domain data 342 and, at least during training, transforms input target domain data 304 to output source domain data 362. For example, the domain transfer network 300 can receive a sequence of data in a source domain, e.g., daytime data, and output a sequence of data in a target domain, e.g., nighttime data.

The domain transfer network 300 processes the source domain data 302 using one or more source domain low-level encoder neural network layers 310 that are specific to data from the source domain to generate a low-level representation 312 of the input source domain data. For example, the source domain low-level encoder neural network layers 310 are used when encoding data from the source domain and not when encoding data from the target domain. The low-level representation 312 is the output of the last of the low-level encoder layers.

The domain transfer network 300 then processes the low-level representation 312 using one more high-level encoder neural network layers 320 that are shared between data from the source and target domains to generate an embedding 322 of the input source domain data 302 and the input target domain data 304, respectively. That is, the high-level encoder neural network layers 320 are used to generate the embedding 322 based on the source domain data and target domain data. The embedding 322 can be a vector of probability distributions where each probability distribution represents a latent attribute or latent attributes of the input data. In the present context, a vector means an ordered collection of numerical values, and a latent attribute is a feature within the input data. For example, a latent attribute for an input image of a person may be a feature representing an eye or a nose. In another example, a latent attribute for an input image of a vehicle may be a feature representing a tire, a bumper, or a vehicle body portion.

The domain transfer network 300 processes the embedding 322 of the input source domain data using one or more high-level decoder neural network layers 330 that are shared between data from the source and target domains to generate a high-level feature representation 332 of features of the input source domain data 302. The high-level latent representation is the output of the last of the high-level decoder layers 330.

The domain transfer network 300 then processes the high-level feature representation 332 of the features of the input source domain data using one or more target domain low-level decoder neural network layers 340 that are specific to generating data from the source domain to generate an output target domain data 342 that is from the target domain but that has similar semantics to the input source domain data 302. Similar semantics means that target domain data 342 has regions of pixel values that correspond to the same objects as regions of pixel values in input source domain data 302. For example, the output target domain data 342 may have a distribution of pixel values that matches those of data from the target domain but having similar semantics to the input source domain data 302, meaning that the output target domain data 342 includes objects that are recognizable by a user as being the same objects included in input source domain data 302. For example, target domain data 342 can include a trailer having an A-frame tongue which corresponds to an A-frame trailer tongue occurring in input source domain data 302.

During training, the domain transfer network 300 can also generate output source domain data 362 from input target domain data 304, i.e., to transform target domain data to source domain data having similar semantics as the original target domain data.

In an example implementation, the domain transfer network 300 processes the target domain data 304 using one or more target domain low-level encoder neural network layers 350 that are specific to data from the target domain to generate a low-level representation 352 of the input source domain data to transform an input target domain data 304. The target domain low-level encoder neural network layers 350 may be used only when encoding data from the target domain and not when encoding data from the source domain.

The domain transfer network 300 then processes the low-level representation 352 using the one more high-level encoder neural network layers 320 that are shared between data from the source and target domains to generate an embedding 324 of the input target domain data 304.

The domain transfer network 300 processes the embedding 324 of the input target domain data using the one or more high-level decoder neural network layers 330 that are shared between data from the source and target domains to generate a high-level feature representation 334 of features of the target domain data 304. Similar to the embedding 322, the embedding 324 can be a vector of probability distributions where each probability distribution represents a latent attribute of the input data.

The domain transfer network 300 then processes the high-level feature representation 334 of the features of the input target domain data using one or more source domain low-level decoder neural network layers 360 specific to generating data from the source domain to generate an output source domain data 362 that is from the source domain but having similar semantics to the input target domain data 304. That is, the output source domain data 362 has a distribution data values that matches those of data from the source domain but having similar semantics to the input target domain data 304. For example, a source domain image having one or more objects depicted therein can be generated to the target domain so that the generated target domain images appear to be from the target domain but maintain the semantics, e.g., depict the one or more objects, of the corresponding source domain images. During training, the target domain low-level decoder neural network layers 340 are trained jointly with the target domain low-level encoder neural network layers 350 and the source domain low-level decoder neural network layers 310.

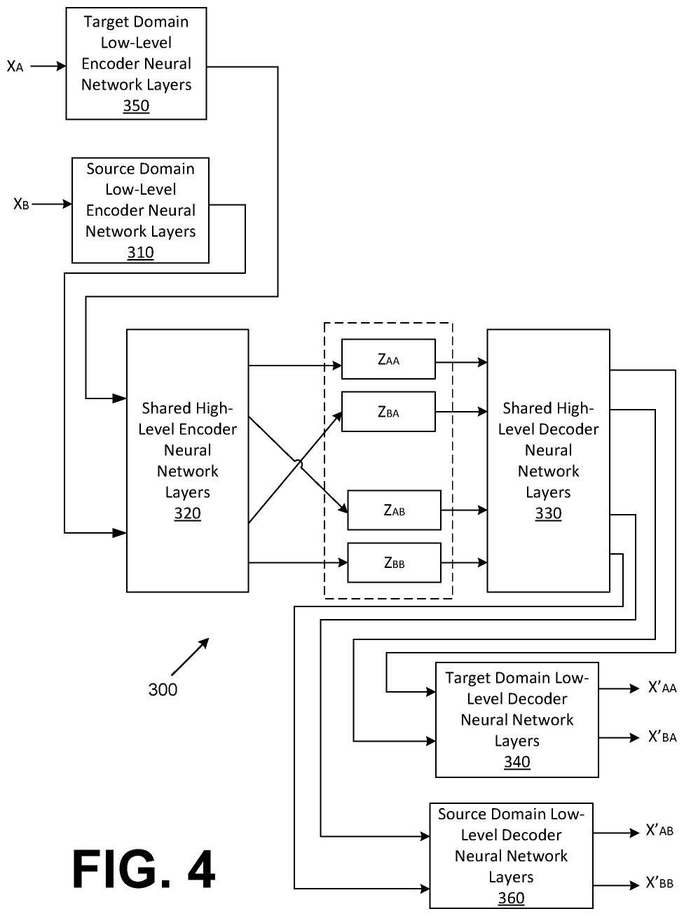

FIG. 4 illustrates an example diagram of the domain transfer network 300 that receives input data X_{A}, X_{B} and can generate output data X′_{AA}, X′_{BA}, X′_{AB}, X′_{BB}. As shown, the target domain low-level encoder neural network layers 350 can receive input X_{A} and the source domain low-level encoder neural network layers 310 can receive input X_{B}. The domain transfer network 300 can perform inter- and intra-domain transformations since the target domain low-level encoder neural network layers 350 and the source domain low-level encoder neural network layers 310 are connected to the source domain low-level decoder neural network layers 360 and the target domain low-level decoder neural network lavers 340 via shared high-level encoder neural network layers 320 and shared high-level decoder neural network layers 330. Domain transfer network 300 is illustrated with shared high-level encoder neural network layers 320 and shared high-level decoder network layers 330 that share weights. Domain transfer network 300 can also operate with high-level encoder neural network layers 320 and high-level decoder network layers 330 that do not share weights.

The input data X_{A} can be data in the source domain where subscript “A” represents a first domain, e.g., daytime image, and the input data X_{B} can be data in the target domain where subscript “B” represents a second domain of the data, e.g., nighttime image. The data X′_{AA}, X′_{BA}, X′_{AB}, X′_{BB} represents output data generated by the domain transfer network 300 where the subscripts each represent inter- and intra-domain transformations of the data X′. For example, if the input data is an image depicting one or more objects in the first domain, the domain transfer network 300 can generate images X′_{AA}, X′_{BA}, X′_{AB}, X′_{BB} that represent an image depicting the one or more objects in the first domain (X′_{AA}), e.g., daytime, a second domain (X′_{BB}), e.g., nighttime, a third domain (X′_{AB}), e.g., morning, and a fourth domain (X′_{BB}), e.g., dusk. The elements Z_{AA}, Z_{AB}, Z_{BA}, Z_{BB} represent the latent attribute or latent attributes generated by the high-level encoder neural network layers 320.

During training, the domain transfer network 300 can modify a conventional loss function of the domain transfer network 300 such that latent attributes are selected from the same probability distribution. A conventional loss function can determine a loss value by calculating a probability that a result and ground truth data correspond to the same probability distribution. Techniques described herein add the constraint that latent attributes are selected from the same probability distribution. By selecting latent attributes from the same probability distribution, features within the input source domain data 304 can be represented in the output target domain data 342. For example, as discussed above, features can represent portions of objects depicted within an image.

The conventional loss function can be modified by minimizing a conventional maximum mean discrepancy (MMD) between the embeddings 322, 324, e.g., the latent attributes Z_{AA}, Z_{AB}, Z_{BA}, Z_{BB}. The maximum mean discrepancy can be defined as a numerical difference between the embeddings 322, 324, such as the difference between a mean of a probability distribution from embedding 322 and a mean of a probability distribution from embedding 324. During training of the domain transfer network 300, the maximum mean discrepancy can be used to modify the conventional loss function to update one or more weights within the domain transfer network 300. Equations 1 through 6 illustrate modification of the conventional loss function (LF) using the maximum mean discrepancy:

L=LF+MMD(Z_{AA},Z_{BB}) Equation 1

L=LF+MMD(Z_{AA},Z_{AB}) Equation 2

L=LF+MMD(Z_{AA},Z_{BA}) Equation 3

L=LF+MMD(Z_{AB},Z_{BA}) Equation 4

L=LF+MMD(Z_{AB},Z_{BB}) Equation 5

L=LF+MMD(Z_{BA},Z_{BB}) Equation 6,

where L is defined as a loss function of the domain transfer network 300. LF is defined as a conventional loss function, and MMI) is defined as the maximum mean discrepancy between the latent attributes. During training, the loss function L can be used to update one or more weights within the domain transfer network 300.

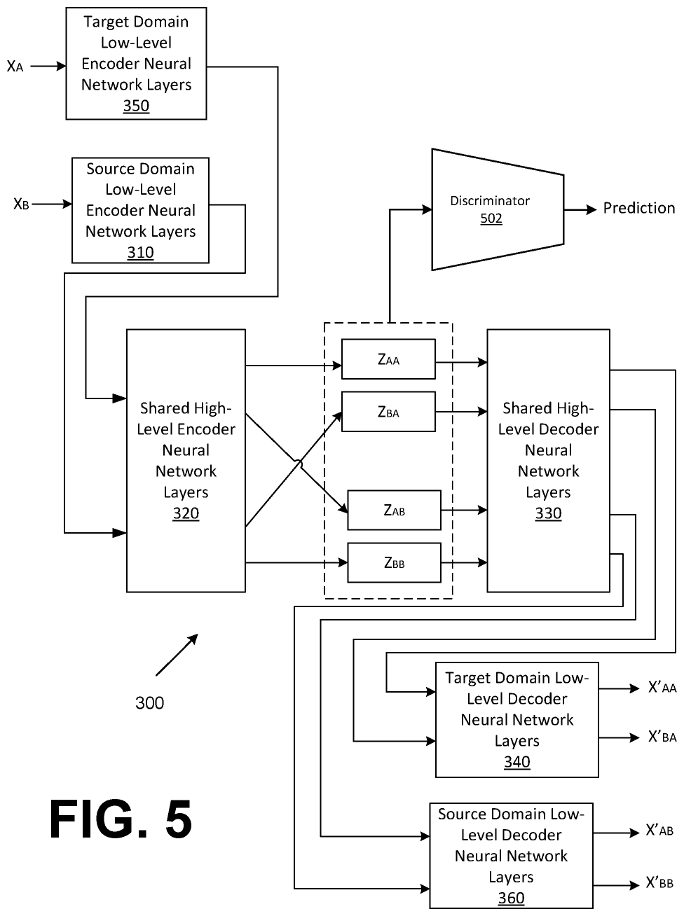

As shown in FIG. 5, the domain transfer network 300 may include a discriminator 502 in some implementations. An output of the discriminator 502 can be used to update the conventional loss function during training such that latent attributes from the same probability distribution are selected during data generation. The discriminator 502 can receive the latent attributes Z_{AA}, Z_{AB}, Z_{BA}, Z_{BB}, evaluate the latent attributes \tilde{Z}_{AA}, \tilde{Z}_{AB}, \tilde{Z}_{BA}, \tilde{Z}_{BB}, and generate a prediction indicative of whether the latent attributes Z_{AA}, Z_{AB}, Z_{BA}, Z_{BB} correspond to a particular domain. In various implementations, the discriminator 502 can comprise one or more Convolution-BatchNorm-ReLU layers as discussed below.

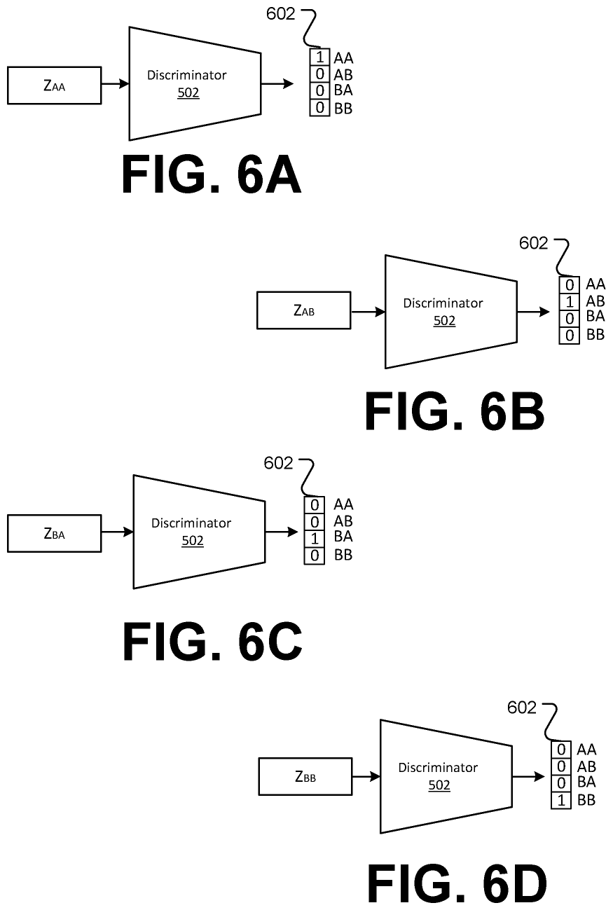

As shown in FIGS. 6A through 6D, the discriminator 502 can receive a latent attribute and output a multi-dimensional vector 602 classifying the corresponding latent attribute to a particular domain. In the examples illustrated in FIGS. 6A through 6D, the multi-dimensional vector 602 comprises a four-dimensional vector including a prediction label representing which domain the corresponding latent attribute is from. For instance, the discriminator 502 generates a “1” within the multi-dimensional vector 602 corresponding to the predicted domain and a “0” for all other domains. In some implementations, the multi-dimensional vector 602 may comprise a two-dimensional vector 602. In these implementations, the discriminator 502 generates a prediction between the first domain and the second domain.

Equation 7 μlustrates a loss function for a discriminator 502 that generates a four-dimensional vector: L_{D}=\tilde{Z}_{AA} log D(B_{AA})+\tilde{Z}_{BB} log D(Z_{BB})+\tilde{Z}_{AB} log D(Z_{AB})+\tilde{Z}_{BA} log D(Z_{BA}) Equation 7, where L_{D} is defined as a loss function for the discriminator 502, \tilde{Z}_{AA}, \tilde{Z}_{BB}, \tilde{Z}_{AB}, \tilde{Z}_{BA} are defined as labels for the corresponding domain, log D is defined as the discriminator's 302 estimate that the probability for the latent attribute corresponds to a specific domain, and Z_{AA}, Z_{AB}, Z_{BA}, Z_{BB} are defined as predicted domain outputs from the discriminator 502, e.g., “0” or “1.” Equation 8 illustrates a loss function for a discriminator that generates a two-dimensional vector:

L_{D}=\tilde{Z}_{AA} log D(Z_{AA})+\tilde{Z}_{BB} log D(Z_{BB}) Equation 8,

where L_{D} is defined as a loss function for the discriminator 502, \tilde{Z}_{AA}, \tilde{Z}_{BB} are defined as labels for the corresponding domain, log D is defined as the discriminator's 302 estimate that the probability for the latent attribute corresponds to a specific domain, and Z_{AA}, Z_{BB} are defined as predicted domain outputs from the discriminator 502, e.g., “0” or “1.” The loss function L_{D} can be used to update weights of the discriminator 502 and/or a conventional loss function of the domain transfer network 300.

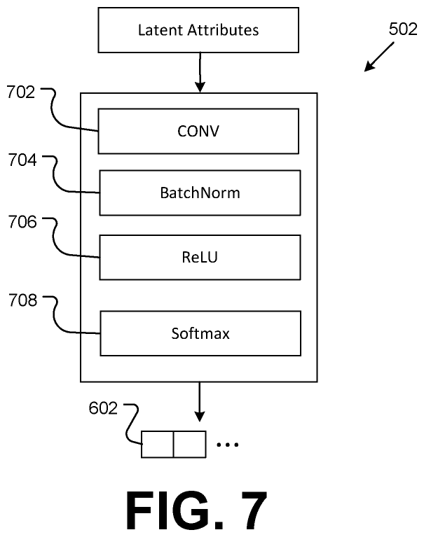

FIG. 7 is a block diagram illustrating an example of the discriminator 502. The discriminator architecture is assumed to be convolutional with standard components (e.g. Cony-BatchNorm-ReLU) being used internally. Conv-BatchNorm-ReLU is a technique for training neural networks that processes latent variables between convolutional layers of a neural network by performing batch normalization (BatchNorm) to avoid problems caused by widely varying input data values and rectified linear activation (ReLU) to speed up convergence during training. The latent variables can be batched together by saving results from a series of training runs and normalized to give the batched latent variables a mean of zero and a standard deviation of one without changing output results. The normalized latent variables can then be subject to ReLU by outputting positive values directly to the succeeding stage and converting negative values to zero.

The discriminator 502 may include multiple different types of layers based on connectivity and weight sharing. As shown in FIG. 7, the discriminator 502 can include one or more convolutional layers (CON′) 702, one or more batch normalization layers (BatchNorm) 704, and one or more rectified linear unit layers (ReLU) 706, The convolutional layers 702 can include one or more convolutional filters that are applied to the latent attributes. The filtered latent attributes can be provided to the batch normalization layers 704, and the batch normalization layers 704 normalizes the filtered latent attributes. The normalized filtered latent attributes can be provided to the rectified linear unit layers 706, and the rectified linear unit layers 706 comprise an activation function, e.g., a piecewise linear function, that generates an output based on the normalized filtered latent attributes. The output of the rectified linear unit layers 706 can be provided to a softmax layer 708 as input to generate the predicted domain. The softmax layer 708 comprises the final layer of the discriminator 502 and is an activation function that generates a probability of which domain the normalized filtered latent attributes belongs. While only a single convolutional layer 702, batch normalization layer 704, rectified unit layer 706, and softmax layer 708 is shown, the discriminator 502 can include additional layers depending on the implementation of the discriminator 502.

A deep neural network trained using techniques described herein can improve training of deep neural networks by permitting one-shot or few-shot training. As discussed above, generating training datasets for deep neural network can require acquiring thousands of example input images along with corresponding ground truth. The training dataset should include a plurality of examples of all of the different types of objects a trained in examples of all of the environmental conditions expected during operation of the deep neural network. For example, a deep neural network can be trained to identify and locate vehicle trailers. During training all of the types and configurations of trailers to be encountered when operating a vehicle should be included in a training dataset. Further, each type and configuration of trailer in the training dataset should be included in each of the different environmental conditions to be encountered when operating the deep neural network. Environmental conditions include weather and lighting conditions such as rain, snow, fog, bright sunlight, night, etc.

Acquiring training dataset that include a plurality of images that include all types and configurations of objects to be identified and located in all types of environmental conditions can be expensive and time-consuming. Techniques discussed herein can improve training of deep neural networks by permitting the deep neural networks to be trained using a single input image and modifying the input image to simulate different types of objects in different configurations in different environmental conditions. For example, a new type or configuration of object can be acquired by a vehicle during operation. The single image of an object can be passed back to a server computer and used to retrain a deep neural network by simulating a plurality of orientations and locations of the new object based on previously acquired training images that include ground truth. Techniques described herein permit training a deep neural network using limited training datasets thereby saving time and money.

Techniques described herein can be applied to deep neural networks that process image data, video data, and human speech data. Images can be processed using convolutional neural networks. Convolutional neural networks include convolutional layers that encode images to form latent variables that can be decoded by convolutional layers that reconstruct the latent variables to form output image data. Video data and human speech data can be processed using recurrent neural networks. Recurrent neural networks include memory that stores results from a plurality of previous decoding layers and previous encoding layers to combine with current encoding and decoding layers. In an example recurrent neural network that processes video data the encoding and decoding layers can include convolutional layers. In an example recurrent neural network that processes human speech, the encoding and decoding layers can be fully-connected layers. Example convolutional neural networks or recurrent neural networks can be configured as domain transfer networks including loss functions and discriminators as described above in relation to FIGS. 3-7 to permit the convolutional neural networks or recurrent neural networks to process image data, video data, or human speech data from a source domain to a target domain and thereby improve the ability to train neural networks by increasing the amount of training data without requiring additional acquisition of real-world data and corresponding ground truth thereby saving time and money.

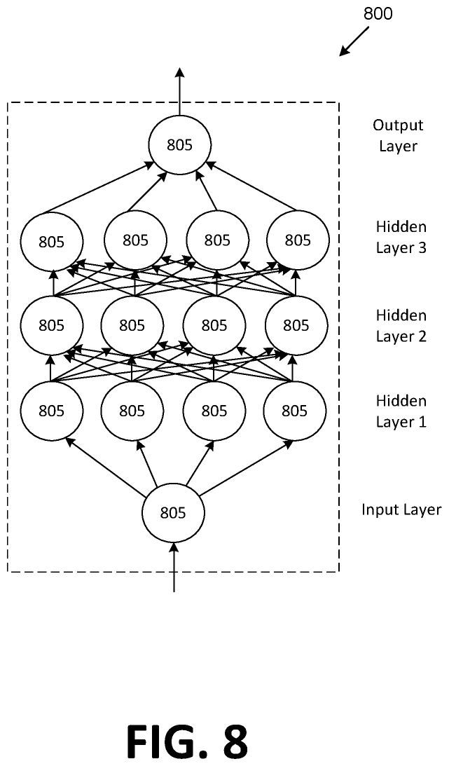

FIG. 8 illustrates an example deep neural network (DNN) 800 that can perform the functions described above and herein. For example, the domain transfer network 300 can be implemented as one or more DNNs 800. The DNN 800 can be a software program that can be loaded in memory and executed by a processor included in the computer 110 or the server 145, for example. In an example implementation, the DNN 800 can include, but is not limited to, a convolutional neural network (CNN), R-CNN (regions with CNN features), Fast R-CNN, Faster R-CNN, and recurrent neural networks (RNNs). The DNN 800 includes multiple nodes 805, and the nodes 805 are arranged so that the DNN 800 includes an input layer, one or more hidden layers, and an output layer. Each layer of the DNN 800 can include a plurality of nodes 805. While FIG. 8 illustrates three (3) hidden layers, it is understood that the DNN 800 can include additional or fewer hidden layers. The input and output layers may also include more than one (1) node 805.

The nodes 805 are sometimes referred to as artificial neurons 805, because they are designed to emulate biological, e.g., human, neurons. A set of inputs (represented by the arrows) to each neuron 805 are each multiplied by respective weights. The weighted inputs can then be summed in an input function to provide, possibly adjusted by a bias, a net input. The net input can then be provided to activation function, which in turn provides a connected neuron 805 an output. The activation function can be a variety of suitable functions, typically selected based on empirical analysis. As illustrated by the arrows in FIG. 8, neuron 805 outputs can then be provided for inclusion in a set of inputs to one or more neurons 805 in a next layer.

The DNN 800 can be trained to accept data, e.g., from the vehicle 105 CAN bus, sensors, or other network, as input and generate a distribution of possible outputs based on the input. The DNN 800 can be trained with ground truth data, i.e., data about a real-world condition or state. For example, the DNN 800 can be trained with ground truth data or updated with additional data by a processor of the server 145. The DNN 800 can be transmitted to the vehicle 105 via the network 135. Weights can be initialized by using a Gaussian distribution, for example, and a bias for each node 805 can be set to zero. Training the DNN 800 can including updating weights and biases via suitable techniques such as back-propagation with optimizations. Ground truth data can include, but is not limited to, data specifying objects within an data or data specifying a physical parameter, e.g., angle, speed, distance, or angle of object relative to another object.

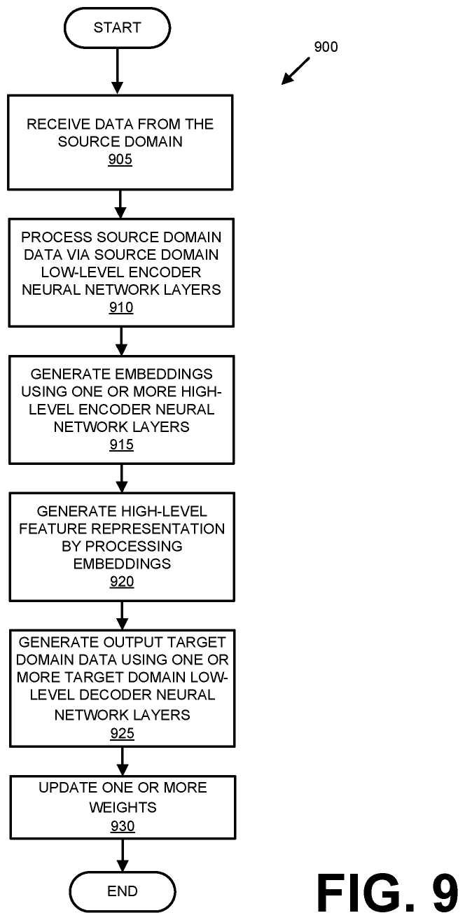

FIG. 9 is a flow diagram of an example process 900 for generating target domain data from source domain data. Blocks of the process 900 can be executed by a processor of the computer 110 and/or the server 145. The process 900 can begin at block 905 in which data, e.g., an image, from the source domain is received. The source domain data is processed using one or more source domain low-level encoder neural network layers that are specific to data from the source domain to generate a low-level representation of the input source domain data at block 910.

At block 915, the low-level representation is processed using one more high-level encoder neural network layers that are shared between data from the source and target domains to generate an embedding, e.g., latent attributes, of the input source domain data. At block 920, the embeddings of the input source domain data are processed using one or more high-level decoder neural network layers that are shared between data from the source and target domains to generate a high-level feature representation of features of the input source domain data.

At block 925, the high-level feature representation of the features of the input source domain data is processed using one or more target domain low-level decoder neural network layers that are specific to generating data from the target domain generate output target domain data that is from the target domain but that has similar semantics to the input source domain data.

At block 930, one or more weights of the domain transfer network are updated based on a loss function. In an example implementation, the maximum mean discrepancy between various embeddings is calculated. In this implementation, the maximum mean discrepancy is used to modify a conventional loss function. In another example implementation, the domain transfer network includes a discriminator, and the discriminator generates a prediction of which domain an embedding belongs. The prediction can be compared to ground truth data, and the loss function for the discriminator can be updated based on the comparison. Additionally or alternatively, weights of the domain transfer network can be updated based on the comparison. The domain transfer network can update its weights according to an update rule, e.g., an ADAM update rule, a Stochastic gradient descent (SGD) update rule. The process 900 then ends.

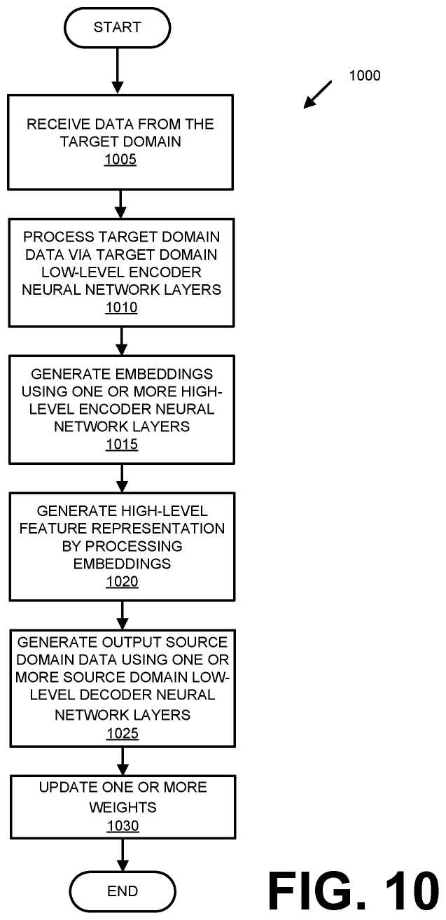

FIG. 10 is a flow diagram of an example process 1000 for generating source domain data from target domain data. Blocks of the process 1000 can be executed by a processor of the computer 110 and/or the server 145. The process 1000 can begin at block 1005 in which data from the target domain is received. At block 1010, the target domain data is processed using one or more target domain low-level encoder neural network layers that are specific to data from the target domain to generate a low-level representation of the input target domain data. The low-level representation is processed using the one more high-level encoder neural network layers that are shared between data from the source and target domains to generate an embedding of the input target domain data at block 1015.

At block 1020, the embedding of the input target domain data is processed using the one or more high-level decoder neural network layers that are shared between data from the source and target domains to generate a high-level feature representation of features of the input target domain data. At block 1025, the high-level feature representation of the features of the input target domain data is processed using one or more source domain low-level decoder neural network layers that are specific to generating data from the source domain to generate output source domain data that is from the source domain but that has similar semantics to the input source domain data.

At block 1030, one or more weights of the domain transfer network are updated based on a loss function. In an example implementation, the maximum mean discrepancy between various embeddings is calculated. In this implementation, the maximum mean discrepancy is used to modify a conventional loss function. In another example implementation, the domain transfer network includes a discriminator, and the discriminator generates a prediction of which domain an embedding belongs. The prediction can be compared to ground truth data, and the loss function for the discriminator can be updated based on the comparison. Additionally or alternatively, weights of the domain transfer network can be updated based on the comparison. The domain transfer network can update its weights according to an update rule, e.g., an ADAM update rule, a Stochastic gradient descent (SGD) update rule.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to cause the processor to:
generate a low-level representation of the input source domain data by processing source domain data using a source domain low-level encoder neural network layer corresponding to data from the source domain to generate a low-level representation of the input source domain data;
generate an embedding of the input source domain data by processing the low-level representation using a high-level encoder neural network layer shared between data from the source and target domains;
generate a high-level feature representation of features of the input source domain data by processing the embedding of the input source domain image using a high-level decoder neural network layer shared between data from the source and target domains to generate a high-level feature representation of features of the input source domain data;
generate output target domain data in the target domain that includes semantics corresponding to the input source domain data by processing the high-level feature representation of the features of the input source domain data using a domain low-level decoder neural network layer that generate data from the target; and
modify a loss function such that latent attributes corresponding to the embedding are selected from a same probability distribution.

2. The system of claim 1, wherein the low-level encoder neural network layer, the high-level encoder neural network layer, the low-level decoder neural network layer, and the high-level decoder neural network layer are included in convolutional neural networks.

3. The system of claim 1, wherein the low-level encoder neural network layer, the high-level encoder neural network layer, the low-level decoder neural network layer, and the high-level decoder neural network layer are included in recurrent neural networks.

4. The system of claim 1, wherein the input source domain and the target domain include image data, video data, and human speech data.

5. The system of claim 1, wherein the processor is further programmed to:
modify the loss function by calculating a maximum mean discrepancy between a first latent attribute corresponding to a source domain and a second latent attribute corresponding to a target domain.

6. The system of claim 1, wherein the processor is further programmed to:
modify the loss function based on a prediction from a discriminator, wherein the prediction is indicative of a domain corresponding to a latent attribute.

7. The system of claim 6, wherein the discriminator comprises one or more convolutional layers, one or more batch normalization layers, and one or more rectified linear unit layers.

8. The system of claim 7, wherein a final layer of the discriminator comprises a softmax layer.

9. The system of claim 6, wherein the discriminator generates a multidimensional vector representing the prediction.

10. The system of claim 9, wherein the multidimensional vector comprises a four-dimensional vector corresponding to four domains.

11. The system of claim 9, wherein the multidimensional vector comprises a two-dimensional vector corresponding to two domains.

12. The system of claim 6, wherein a loss function for the discriminator comprises:
L_{D}=\tilde{Z}_{AA} log D(Z_{AA})+\tilde{Z}_{BB} log D(Z_{BB})+\tilde{Z}_{AB} log D(Z_{AB})+\tilde{Z}_{BA} log D(Z_{BA}), where L_{D} is defined as the loss function, \tilde{Z}_{AA}, \tilde{Z}_{BB}, \tilde{Z}_{AB}, \tilde{Z}_{BA} are defined as labels for the corresponding domain, log D is defined as an estimate that the probability for the latent attribute corresponds to a specific domain, and Z_{AA}, Z_{AB}, Z_{BA}, Z_{BB} are defined as predicted domain outputs.

13. The system of claim 1, wherein the processor is further programmed to:
generate a low-level representation of the input target domain data by processing the input target domain data using a target domain low-level encoder neural network layer specific to data from the target domain;
generate an embedding of the input target domain data by processing the low-level representation using a high-level encoder neural network layer that is shared between data from the source and target domains;
generate a high-level feature representation of features of the input target domain data by processing the embedding of the input target domain image using the high-level decoder neural network layer shared between data from the source and target domains; and
generate output source domain data from the source domain that includes semantics corresponding to the input target domain data by processing the high-level feature representation of the features of the target source domain image using a source domain low-level decoder neural network layer that is specific to data from the source domain.

14. A method comprising:
generating a low-level representation of the input source domain data by processing source domain data using a source domain low-level encoder neural network layer corresponding to data from the source domain to generate a low-level representation of the input source domain data;
generating an embedding of the input source domain data by processing the low-level representation using a high-level encoder neural network layer shared between data from the source and target domains;
generating a high-level feature representation of features of the input source domain data by processing the embedding of the input source domain image using a high-level decoder neural network layer shared between data from the source and target domains to generate a high-level feature representation of features of the input source domain data;
generating output target domain data in the target domain that includes semantics corresponding to the input source domain data by processing the high-level feature representation of the features of the input source domain data using a domain low-level decoder neural network layer that generate data from the target; and
modifying a loss function such that latent attributes corresponding to the embedding are selected from a same probability distribution.

15. The method of claim 14, wherein the low-level encoder neural network layer, the high-level encoder neural network layer, the low-level decoder neural network layer, and the high-level decoder neural network layer are included in convolutional neural networks.

16. The method of claim 14, wherein the w-level encoder neural network layer, the high-level encoder neural network layer, the low-level decoder neural network layer, and the high-level decoder neural network layer are included in recurrent neural networks.

17. The method of claim 14, wherein the input source domain and the target domain include image data, video data, and human speech data.

18. The method of claim 14, further comprising:
modifying the loss function by calculating a maximum mean discrepancy between a first latent attribute corresponding to a source domain and a second latent attribute corresponding to a target domain.

19. The method of claim 14, further comprising:
modifying the loss function based on a prediction from a discriminator, wherein the prediction is indicative of a domain corresponding to a latent attribute.

20. The method of claim 14, wherein the discriminator comprises one or more convolutional layers, one or more batch normalization layers, and one or more rectified linear unit layers.
